(19) United States
(12) Patent Application Publication
(10) Pub. No.: US 2010/0129064 A1
(43) Pub. Date: May 27, 2010

(54) Drive recorder

(75) Inventors: Munenori Maeda, Kobe-shi (JP); Fujio Tonokawa, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/591,084

(22) Filed: Nov. 6, 2009

(30) Foreign Application Priority Data
Nov. 25, 2008 (JP) 2008-300200

(51) Int. Cl. H04N 7/26

(52) U.S. Cl. 386/124; 386/E05.001

(57) ABSTRACT

An object of the present invention is to provide a drive recorder capable of recording video information at the time of an accident or the like and constant recording. The drive recorder according to the present invention has a controller that constantly records information captured by the imaging unit onto a nonvolatile recording medium, and records information captured by the imaging unit onto a nonvolatile recording medium when a predetermined recording condition is established.

This application is a new U.S. Patent Application that claims priority of Japanese Application No. 2008-300200, filed Nov. 25, 2008, the content thereof is incorporated herein by reference.

### FIELD OF THE INVENTION

The present invention relates to a drive recorder, and relates particularly to a drive recorder for recording information onto a recording medium having limited recording capacity.

### BACKGROUND OF THE INVENTION

Conventionally, a vehicle-mounted image recording device known as a drive recorder has been proposed, which picks up an image of the surroundings of a vehicle by a camera installed in the vehicle, and records a surrounding image and vehicle speed when impact is applied to the vehicle due to a collision or rapid braking. When the drive recorder is provided in a vehicle, it is possible to verify the cause of an accident, by analyzing recorded information. The drive recorder can also raise a drivers' consciousness about safe driving, and provide a recorded image of daily driving to help improve driving safety.

There are disclosed drive recorders that cyclically record images captured by a vehicle-mounted camera, and record images recorded at an accident occurrence time into other recording medium (see Patent Documents 1 and 2, for example).

There is also known a data recording device capable of recording a large amount of data in an easily searchable format by using a ring buffer, though this is not a drive recorder (see Patent Document 3, for example).

Patent Document 1: JP-S63-16785-A

Patent Document 2: JP-H06-237463-A

Patent Document 3: JP-2008-97107-A

### SUMMARY OF THE INVENTION

However, when an impact is small, a G sensor output based on the impact is small, and cannot trigger a recording of information, resulting in a failure of recording video information. Further, when there is an accident generating large impact, video information during only a predetermined period before and after the occurrence of the impact is recorded. Therefore, necessary video information is not recorded when the cause of a large accident arises before the accident occurs.

On the other hand, when video information is always recorded, all information cannot be recorded onto a recording medium having limited recording capacity.

It is an object of the present invention to provide a drive recorder capable of solving the above problems.

It is another object of the present invention to provide a drive recorder capable of combining in good condition recording of video information when an accident occurs and constant recording.

A drive recorder according to the present invention has a controller that constantly controls record information captured by an imaging unit into a nonvolatile recording medium, and record information captured by the imaging unit into a nonvolatile recording medium when a predetermined recording condition is established.

The drive recorder according to the present invention records video information based on establishment of a recording condition when an accident generating large impact occurs. The drive recorder constantly and cyclically records video information onto the recording medium, even when such large impact is not generated. Therefore, it is possible to understand a detailed dangerous state of a vehicle installed with the drive recorder, from the recorded video information and the like.

### DESCRIPTION OF THE DRAWING

These and other features and advantages of the present invention will be better understood by reading the following detailed description, taken together with the drawings wherein:

FIG. 1 is a view showing an example that a drive recorder is installed in a vehicle;

FIG. 2 is a view showing an example that a drive recorder and the like are arranged in a vehicle;

FIG. 3 is a view showing an example that a main body of a drive recorder is arranged in a vehicle;

FIG. 4 shows an example of an external view of a reproducing device;

FIG. 5 is a block diagram showing an electrical configuration of a drive recorder;

FIG. 6 is a block diagram showing an electrical configuration of a reproducing device;

FIG. 7 shows an example of utilizing a recording area of a memory card;

FIG. 8 shows an example of a method of recording video information and the like;

FIG. 9 is a flowchart of an example of operation of a memory card 6; and

FIG. 10 shows an example of a display screen.

### DETAILED DESCRIPTION OF THE PREFERRED EMBODIMENT

A drive recorder according to the present invention is explained below with reference to the drawings. However, the technical range of the present invention is not limited to the embodiments, and includes inventions described in the claims and their equivalents.

First, recording of information by the drive recorder is explained.

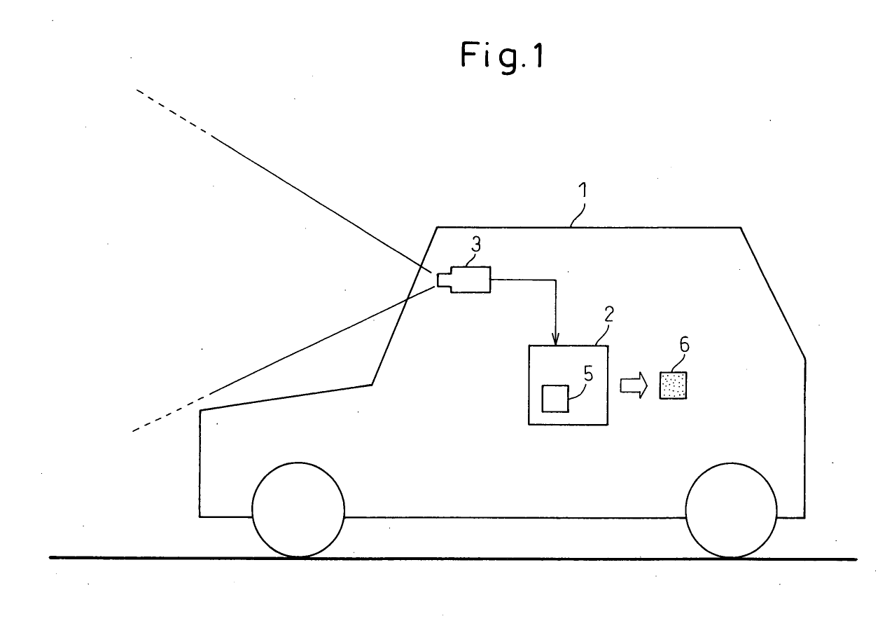

FIG. 1 shows an example that a drive recorder 2 is installed in a vehicle 1.

The drive recorder 2 is installed in the vehicle 1, and is connected to a camera 3 that images the front of the vehicle 1. Video information obtained by the camera 3 is cyclically recorded into a semiconductor recording unit within the drive recorder 2. When a predetermined recording condition is established, the video information recorded in the semiconductor recording unit is cyclically recorded into a memory card 6. Even when a predetermined recording condition is not established, the video information recorded in the semiconductor recording unit is constantly and cyclically recorded into the memory card. The predetermined recording condition is that impact is applied to the vehicle 1 due to the occurrence of an accident or the like, and this is described in detail later. A detail of the cyclical recording into the memory card 6 is also described later.

The drive recorder 2 obtains operation information containing speed information of a vehicle and the like in addition to the video information, and cyclically records the information into the semiconductor recording unit within the drive recorder 2. The operation information is cyclically recorded into the memory card 6 together with the video information. A detail of the operation information is described later.

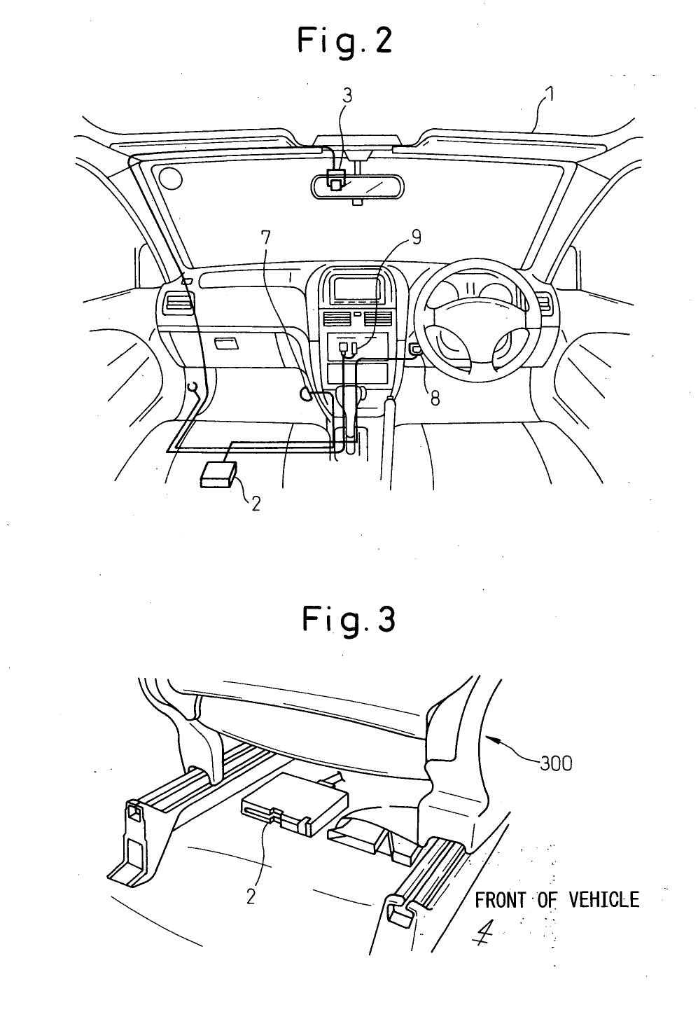

FIG. 2 shows an example of installment of the drive recorder 2 in the vehicle 1.

The drive recorder 2 is electrically connected to the camera 3, a microphone 7, and an imaging switch 8. The camera 3 is fitted to a front glass surface at the rear side of a mirror within the vehicle, captures an image of the front of the vehicle, and transmits the video information to the drive recorder 2. The microphone 7 is installed near the foot at the side of a front passenger seat, and collects voice and sound within the vehicle 1. The imaging switch 8 is installed near a steering wheel. A user can operate the imaging switch 8 to record the video information captured by the camera 3 onto the drive recorder 2. Although the drive recorder 2 is connected to only one camera 3 in FIG. 1 and FIG. 2, plural cameras can be arranged to capture images of the backside, sideways, and within the vehicle, and the plural cameras can also be connected to the drive recorder 2.

FIG. 3 shows an example that a main body of the drive recorder 2 is installed in the vehicle 1.

The main body of the drive recorder 2 can be installed in a lower space of a front passenger seat 300. The main body is fixedly installed to control recording of video information and the like when impact is applied to the vehicle 1.

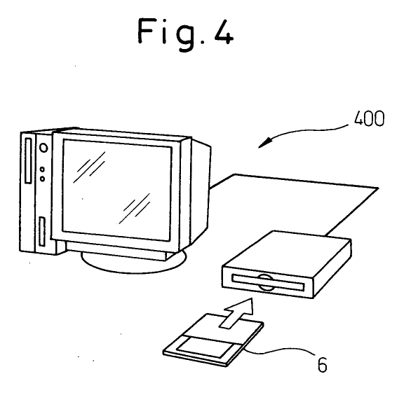

FIG. 4 shows an external view of a reproducing device.

A reproducing device 400 configured by a personal computer and the like reproduces video information and operation information recorded on the memory card 6. The memory card 6 is inserted into an interface (I/F) connected to the personal computer, and the video information and the operation information are read out from the memory card. As described later, the reproducing device 400 can reproduce the video information and the like recorded on the memory card 6.

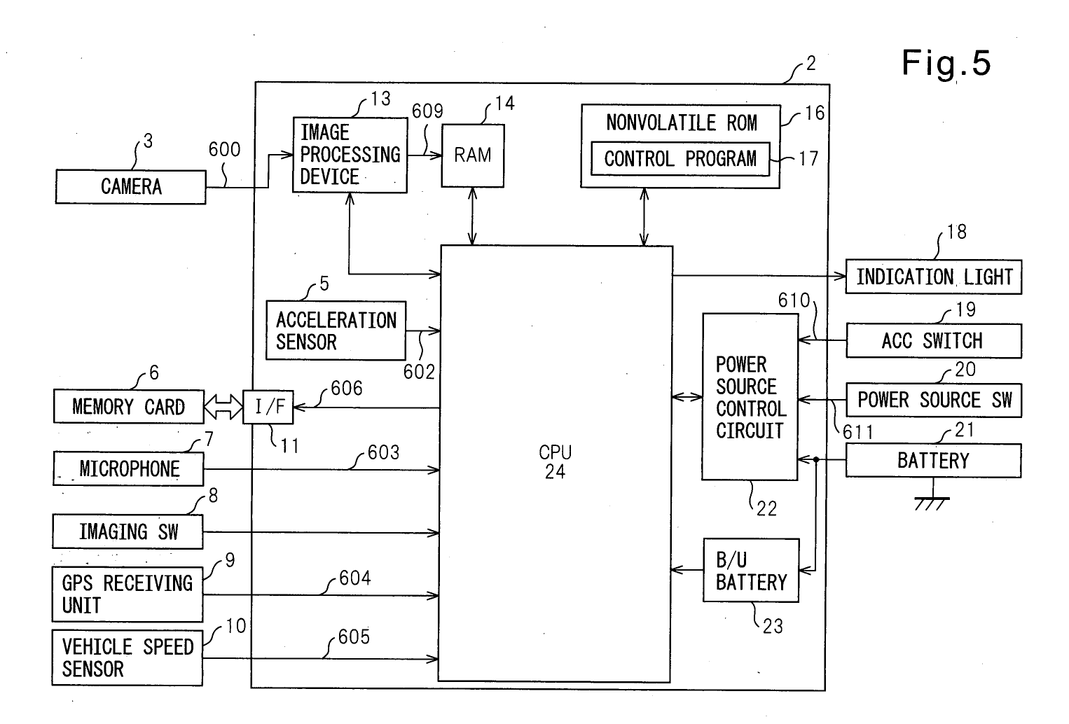

FIG. 5 is a block diagram showing an electrical configuration of the drive recorder 2.

While the drive recorder 2 can be configured in isolation from the camera 3 as an exclusive device to record an image, the drive recorder 2 can be also configured integrally with the camera 3 and the microphone 7 within the same casing. The drive recorder 2 can be also configured as one function of a vehicle-mounted navigation device.

The camera 3 is controlled to image the front of the vehicle 1 and output an analog video signal as video information 600. The camera 3 is configured by a CCD image sensor (Charge Coupled Device Image Sensor) and a CMOS image sensor (Complementary Metal Oxide Semiconductor Image Sensor) as a two-dimensional image sensor, for example.

An acceleration sensor 5 is configured as a G sensor (Gravity Accelerative Sensor) that detects a size of impact applied to the vehicle 1 as gravitational acceleration. The acceleration sensor 5 is configured by a semiconductor that generates a current based on gravitational acceleration upon receiving impact, detects a size of gravitational acceleration in front and back directions and in left and right directions of the vehicle, and outputs the detected size as gravitational acceleration information 602 to a CPU 24.

The memory card 6 is a nonvolatile recording medium removable from the drive recorder 2. An SD card (Secure Digital Memory Card) as a programmable nonvolatile semiconductor memory card is used for the memory card 6. Alternatively, a CF card (Compact Flash Card), a memory stick, etc., as other removable memory cards can be also used. While the memory card 6 is used as a removable recording medium in the present example, a removable hard disc and the like can also be used instead of this memory card.

The microphone 7 is electrically connected to the CPU 24, and is configured to collect voice and sound within or outside the vehicle 1 and transmit the collected sound as sound information 603 to the CPU 24. The sound information 603 is converted into a digital signal by an analog/digital converter within the CPU 24. It is preferable to use a unidirectional microphone having high sensitivity in front of the microphone so as not to record unnecessary noise on the road.

The imaging switch (imaging SW) 8 transmits a press signal to the electrically connected CPU 24 when the imaging switch 8 is operated by the user. Upon receiving the press signal, the CPU 24 controls to record earmark information of video information as one of operation information described later. That is, by operating the imaging SW 8, this scene can be easily searched later.

A GPS (Global Positioning System) receiving unit 9 receives wave signals containing data of a track of a satellite and time data from an atomic clock mounted on the satellite, from plural GPS satellites, calculates a relative distance difference between each satellite and the GPS receiving unit from a time difference of the received waves, and obtains current position information of a vehicle. When radio waves emitted from three satellites are caught, a position of the vehicle on the plane of the surface can be determined. Upon detecting the current position information, the GPS receiving unit 9 transmits GPS information 604 containing the position information and the time information to the CPU 24.

A vehicle speed sensor 10 is configured by a magnetic sensor or an optical sensor that detects rotation of a rotor provided on a wheel axis of the vehicle, and outputs the rotation of the rotor as a rotation pulse signal 605. The CPU 24 calculates a wheel rotation number per unit time from the rotation pulse signal 605 received from the vehicle speed sensor 10, and calculates speed information of the vehicle 1.

An interface (I/F) 11 configures a slot of the memory card 6 provided in the drive recorder 2. The I/F 11 transfers record information 606 containing the video information and the operation information transmitted from the drive recorder 2, to the inserted memory card 6.

An image processing circuit 13 converts the video information 600 input from the camera 3 into a digital signal, prepares image data 609, and outputs this data. For example, the image processing circuit 13 is configured by JPEG-IC (Joint Photographic coding Experts Group-Integrated Circuit), and generates still image data in a JPEG format. In this case, the JPEG-IC does not have a function of outputting data by assigning an address. Therefore, the image processing circuit 13 outputs 30 files of still image data per second (30 data files at every second) to a RAM (Random Access Memory) 14.

The RAM 14 cyclically and constantly records for 40 second components (30×40=1200 files) the still image data (video information) 609 converted by the image processing circuit 13. The RAM 14 also cyclically records operation information described later, by relating the operation information to each still image data. An SDRAM (Synchronous Dynamic Random Access Memory) is used for the RAM 14, for example. The SDRAM is designed to operate synchronously with a clock of the CPU. Therefore, the SDRAM has short input/output waiting time, and can be accessed faster than a conventional DRAM (Dynamic Random Access Memory). Consequently, the SDRAM is suitable to control a process of large-capacity image data at a high speed. The above recording capacity of the RAM 14 is one example, and the capacity is not limited to this.

A nonvolatile ROM 16 stores a control program 17 and the like to collectively control hardware resources constituting the drive recorder 2. A mask ROM can be used for the nonvolatile ROM 16. A flash memory, an EEPROM (Erasable Programmable Read Only Memory), and a ferroelectric memory as programmable nonvolatile semiconductor memories can be also used. When the flash memory, the EEPROM, and the ferroelectric memory are used for the nonvolatile ROM 16, a program can be written onto and erased from the nonvolatile ROM.

The control program 17 is stored in the nonvolatile ROM 16. The control program 17 is read by the CPU 24 at the time of starting the drive recorder 2, and functions as a program to control each unit and perform data process.

An indication light 18 includes a light-emitting diode or the like. During activation of the drive recorder 2, the CPU 24 controls the indication light 18 to be on, thereby notifying the user that the drive recorder 2 is being activated. When an abnormality occurs on the drive recorder 2, the CPU 24 controls the indication light 18 to blink to notify the user of the abnormality.

An accessory switch (ACC switch) 19 is electrically integrated with an engine-start key cylinder provided in the vehicle 1. When the user operates the key to turn on the switch, the ACC switch 19 transmits an accessory-on signal 610 to the drive recorder 2. Upon receiving the accessory-on signal 610 of the ACC switch 19, the drive recorder 2 starts the control. In place of the output signal of the ACC switch 19, an ignition key output signal can be all used.

When the user turns on a power source switch (power source SW) 20, the switch transmits a power-on signal to the drive recorder 2. The power source SW 20 can be used when it is desirable to operate the drive recorder 2 without turning on the ACC switch 19.

A battery 21 is provided in the vehicle 1, and supplies power to the main body of the drive recorder 2. The battery 21 supplies power to a power source control circuit 22 and a backup battery 23. The battery 21 can be any battery that can be installed in the vehicle and can generate 12V electromotive force.

The power source control circuit 22 is connected to the CPU 24, and supplies power from the battery 21 to each part of the CPU 24 and the drive recorder 2, upon receiving an on signal from the ACC switch 19. Upon detecting the operation of the power source SW 20, the power source control circuit 22 starts supplying power regardless of a state of the ACC switch 19. Upon detecting an off state of the ACC switch 19 or the power source SW 20, the power source control circuit 22 transmits an end signal to the CPU 24. Upon receiving the end signal, the CPU 24 transmits an off signal to the power source control circuit 22 as a control-end process. As a result, the power source control circuit 22 stops supplying power.

The backup battery (B/U battery) 23 is configured by a capacitor and the like, and is connected to the CPU 24 and the drive recorder 2 to be able to supply power from this backup battery to each part of these units. When impact is applied to the vehicle 1 due to a collision or the like, there is a risk of breakage of the battery 21 and disconnection of a connection line between the battery 21 and the power source control circuit 22. In this case, the B/U battery 23 supplies accumulated power to the CPU 24 and the like, thereby backing up power supply to the drive recorder 2.

The CPU (Central Processing Unit) 424 is configured by a microcomputer and the like, and operates as a control device of the drive recorder 2. The CPU 24 controls each part of the drive recorder 2 and performs data processing based on the control program 17.

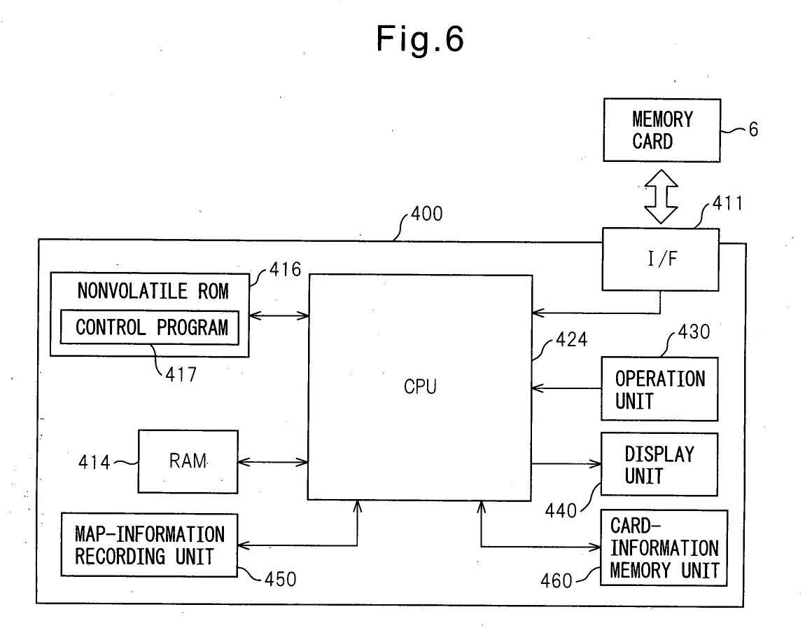

FIG. 6 is a block diagram showing an electrical configuration of the reproducing device 400.

An interface (I/F) 411 configures an entry, known as a slot unit, of the memory card 6 provided in the reproducing device 400. The I/F 411 transfers video information and operation information recorded in the memory card 6, to the reproducing device 400.

A RAM 414 is used to temporarily store data when the CPU 424 performs an image process of video information and an information process of operation information that are transferred from the memory card 6. An SDRAM is used for the RAM 414, for example.

A nonvolatile ROM 416 records a control program 417 and the like to collectively control hardware resources constituting the reproducing device 400. An EEPROM and a ferroelectric memory are used for the nonvolatile ROM 416, for example.

The control program 417 is recorded in the nonvolatile ROM 416, and is read by the CPU 424 when the reproducing device 400 is started. The control program 417 functions as a program to control each unit and perform data process.

The CPU 424 is configured by a microcomputer and the like, and operates as a control device of the reproducing device 400. The CPU 424 performs control of each unit of the reproducing device 400 and data process, based on the control program 417.

An operating unit 430 is configured by a keyboard, a mouse, and the like. When the user operates the reproducing device 400, the operating unit 430 is used to input data into the CPU 424.

A display unit 440 is configured by a liquid-crystal display unit, and is used to appropriately display video information and operation information recorded in the memory card 6.

A map-information recording unit 450 is configured of a recording medium, such as a hard disc or DVD, and records map information containing road information and speed limit information.

A card-information memory unit 460 is configured by a recording medium such as a hard disc, and is used to record video information and operation information recorded in the memory card 6.

Next, a recording procedure of recording video information and operation information into the drive recorder 2 is explained. Two kinds of recording in the drive recorder 2 are present: recording when a predetermined recording condition is established; and constant recording.

A recording condition is established in the following two cases.

1. “G detection”: When the acceleration sensor 5 detects gravitational acceleration equal to or higher than a predetermined threshold value. When the CPU 24 detects at every ten milliseconds an absolute value (Gx²+Gy²)^{0.5} of combined gravitational acceleration of outputs from the acceleration sensor 5, and also a value equal to or higher than a threshold acceleration is detected continuously during a threshold continuous time, it is determined that the recording condition is established. In the above, Gy represents gravitational acceleration in front and back directions of the vehicle 1, and Gx represents gravitational acceleration in left and right direction of the vehicle 1. While threshold acceleration can be set to 0.40G and the threshold continuous time can be set to 100 milliseconds, these values are one example, and are not fixed values.

2. “Speed trigger”: When a speed difference within a predetermined period of the vehicle 1 detected by the vehicle speed sensor 10 becomes equal to or higher than a threshold value. Specifically, running at or above 60 km/h, when deceleration during one second becomes equal to or above 14 km/h, it is determined that the recording condition is established.

The above two recording conditions are one example, and other condition can be also set as a recording condition.

The operation information refers to the following information.

1. Gravitational acceleration information (Gy, Gx) detected from the acceleration sensor 5.

2. Press information of the operation SW 8. This is the information showing that the operation SW 8 is pressed. The operation SW 8 is configured to enable the user to mark information to facilitate reminding the information when some anxious event occurs later.

3. Position information (latitude and altitude information) and time information of the vehicle 1 detected from the GPS receiving unit 9.

4. Speed information detected from the vehicle speed sensor 10.

5. ON/OFF information of the ACC switch 19.

Content of the operation information is not necessarily limited to the above information, and the operation information can also contain information of a lighting state of a light such as a direction blinker and operation and running of the vehicle 1 such as an angle of the steering wheel.

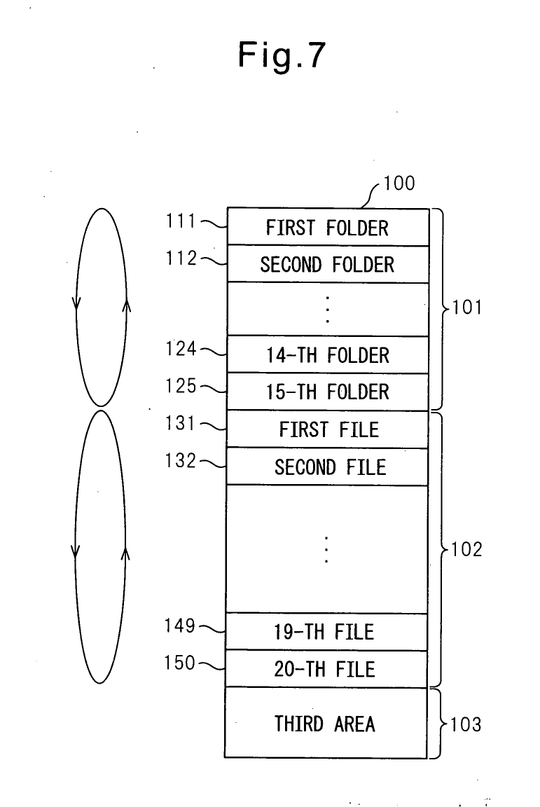

FIG. 7 shows an example of utilizing a recording area of the memory card 6.

A recording area 100 of the memory card 6 is allocated with a first area 101 in which data is recorded when a recording condition is established, and a second area 102 and other area 103 in which data is recorded by constant recording. The other area 103 stores a management program and management data of the memory card 6, an ID intrinsic to the memory card, and an ID (or name data) of a user (a taxi driver, for example) of the memory card 6.

The first area 101 is allocated with 15 areas in total capable of storing folders recorded with video information and operation information when a recording condition is established. That is, when operation is started after inserting the memory card 6 after initialization into the drive recorder 2, data for 15 cases can be recorded into these folders when a recording condition is established.

When a recording condition is first established, video information and operation information are recorded into a first folder 111. Thereafter, these pieces of information are sequentially recorded into a second folder 112, . . . , and a 15-th folder 125. When a recording condition is established at a 16-th time, information is overwritten into the first folder 111. Thereafter, when a recording condition is established at a 17-th time, information is overwritten into the second folder. Information is sequentially recorded in this way. That is, when a recording condition is established, information is cyclically recorded into these folders in the first area 101. While 15 areas are provided to store folders containing information when a recording condition is established, this number of folders is one example and is not limited to 15. In the first area 101, two more detailed areas can be also provided corresponding to a kind of an established recording condition. For example, the first area 101 can be allocated with a detailed area in which eight folders are stored based on “G detection”, and a detailed area in which seven folders are stored based on “speed trigger”. Alternatively, the first area 101 can be structured not to cyclically record information into folders, but perform alarm operation after information is recorded into a predetermined number of folders, without recording information into more folders.

The second area 102 is allocated with 20 files into which video information and operation information can be recorded during a predetermined time by constant recording. Provision of the divided 20 files is to prepare for a risk of inability of reproducing any recorded information when all pieces of information are recorded into one file, in the event of a breakage of this one file. In the present example, video information and operation information can be recorded into each one file during three minutes by constant recording.

When the drive recorder 2 starts constant recording after starting the operation, still image data obtained at a rate of ten frames per second and operation information during a capturing of the still image data are recorded into a first file 131. After a three-minute recording into the first file 131 is completed, information is recorded into the second file. In this way, information is sequentially recorded into the twenty files up to a 20-th file 150. After the recording into the 20-th file 20 is completed, new information is overwritten into the already-recorded data in the first file 131. Thereafter, information is sequentially recorded into a second file 132 and after. That is, video information and operation information based on constant recording are cyclically recorded into the second area. In the present example, while the 20 files by constant recording for a total one hour are provided, the number of files is one example, and is not limited to 20.

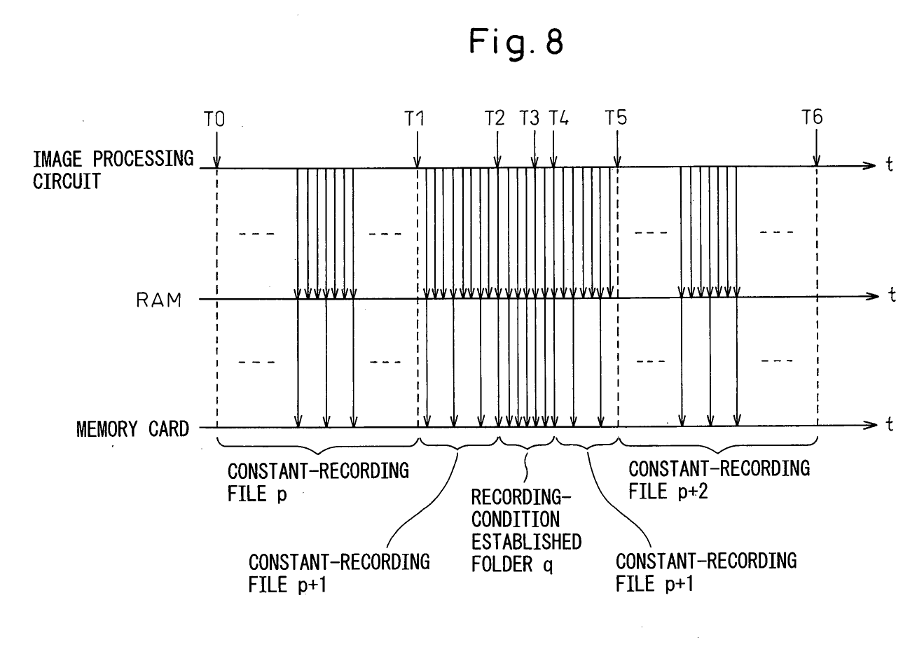

FIG. 8 shows one example of a method of recording video information and the like.

As described above, the image processing circuit 13 outputs still image data to the RAM 14 at a rate of 30 frames per second, and the RAM 14 cyclically stores the input still image data of 30 frames per second. The RAM 14 has recording capacity capable of storing still image data of at least 40 frames per second.

By constant reading, the CPU 24 records still image data of ten frames per second corresponding to one third of the still image data of 30 frames per second cyclically recorded into the RAM 14, into a predetermine file allocated to the second area 102 of the memory card 6. For example, still image data (video information) of ten frames per second during three minutes from time T0 to T1 and operation information at each time of capturing each still image data are recorded into one predetermined file (a constant-recording file p) in the second area 102 of the memory card 6. Similarly, still image data (video information) of ten frames per second during three minutes from time T5 to T6 and operation information at each time of capturing each still image data are recorded into one predetermined file (a constant-recording file (p+2)) in the second area 102 of the memory card 6. That is, by constant recording, still image data is constantly recorded at each predetermined interval of 0.1 second.

When a recording condition is established, out of the still image data cyclically recorded into the RAM 14 at a rate of 30 frames per second, the CPU 24 collectively records into one folder in the first area 101 of the memory card 6, both still image data (video information: 30×20=600 frames) during 12 seconds before establishment of a recording condition and during eight seconds after the establishment of a recording condition and operation information during capturing of the respective still image data. For example, when any one of the above-described recording conditions is established at time T3, the CPU 24 collectively records into one folder (a recording-condition established folder q) in the first area 101 of the memory card 6, both still image data during 12 seconds from time T2 to T3 and during eight seconds from time T3 to T4 and operation information during capturing of the respective still image data. That is, information amount per unit time of video information and operation information recorded into the memory card 6 at the time of establishment of a recording condition is set larger than information amount per unit time of video information and operation information recorded in the memory card 6 in the constant recording.

When a recording condition is established, information can be continuously recorded by constant recording. Alternatively, when a recording condition is established, information can be controlled not to be recorded by constant recording during this period. For example, when a recording condition is established at time T3 during three minutes from time T1 to T5, still image data of 30 frames per second from time T2 to T4 and still image data of ten frames per second from time T1 to T5 can be recorded into a predetermined area of the memory card 6. However, in this case, video information and the like during a period from time T2 to T4 are redundantly recorded.

To avoid this problem, only still image data (video information) of ten frames per second from time T1 to T2 and from time T4 to T5 and operation information during capturing of the still image data are set to be recorded into a predetermined file (a constant-recording file (p+1)) in the second area 102 of the memory card 6. Further, still image data during 20 seconds from time T2 to T4 (30 frames per second) and operation information during capturing of the still image data are set to be collectively recorded into one folder and stored in a predetermined area of the first area 101 of the memory card 6. Thereafter, in the reproducing device 400, the CPU 424 can reproduce the video information and the like of three seconds from time T1 to T5 by constant recording, by combining these pieces of information, by using the constant-recording file (p+1) and the folder q at the time of the establishment of a recording condition. That is, the CPU 424 of the reproducing device 400 extracts still image data of ten frames per second during time T2 to T4 and operation information corresponding to this still image data from the folder q at the time of establishment of the recording condition, and combines the extracted information with data recorded in the constant recording file (p+1), thereby forming data of the time T1 to T5 by constant recording.

The above-described number of frames of still image data per unit time recorded at the time of establishment of a recording condition, the number of frames of still image data per unit time recorded by constant recording, and the recording time of one file are all one example, and are not limited to these values.

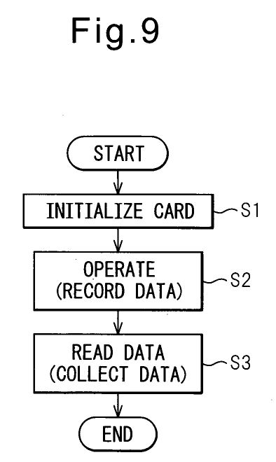

FIG. 9 is a diagram showing a flow of an example of operation of the memory card 6.

First, the user initializes the card 6 by inserting the card into the I/F 411 of the reproducing device 400

(S1). In the initialization of the card, the data so far stored in the memory card 6 by the CPU 424 is erased, and the card 6 is formatted to have the first area 102 to the third area 103 and allocation within each area as shown in FIG. 7. Further, the ID intrinsic to the memory card 6, and the ID or name data of a user (a taxi driver, for example) who uses the memory card 6 are recorded into the third area 103.

Next, the user inserts the initialized memory card 6 into the I/F 11 of the drive recorder 2 of the vehicle 1 that the user drives, at an operation starting time (for example, a starting time of day shift (7:45 to 17:15)) (S2). Consequently, when any one of the above-described two recording conditions is established, video information and operation information are cyclically recorded into the first area 101 of the memory card 6 in a folder unit, and video information and operation information by constant recording are cyclically recorded into the second area of the memory card 6

At the end of the operation (for example, when the taxi driver ends the daily shift), the user takes out the inserted memory card 6 from the I/F 11 of the drive recorder 2 of the vehicle 1, and then inserts the memory card 6 into the I/F 411 of the reproducing device 400 to transfer the recorded video information and operation information to the card-information memory unit 460 of the reproducing device 400, thereby recording the transferred information (S3). As a result, a series of process ends. The data recorded in the memory card 6 is transferred to the reproducing device 400 for each one operation of one vehicle in principle. However, one memory card 6 can be also used for plural vehicles and for plural operations.

In the reproducing device 400, the CPU 424 adds the video information and the operation information in each folder at the time of establishment of a recording condition recorded in the memory card 6, to the ID of the memory card and the ID of the user and read date and time data read in plural files by constant reading, and records the added information in the card-information memory unit 460.

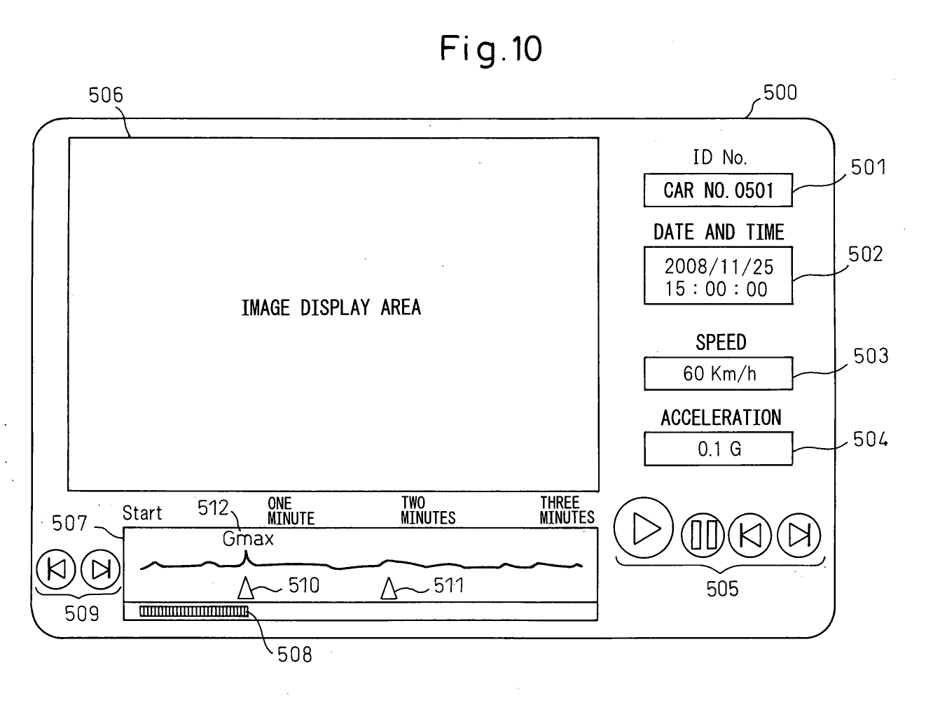

FIG. 10 is a diagram showing an example of a display screen.

FIG. 10 shows one example of a screen 500 to reproduce one file by constant recording displayed in the display unit 440 of the reproducing device 400. The CPU 424 performs all display process of the screen and a process based on operation of an operator on the screen described later.

A vehicle ID 501, time information 502 when reproduced still image data is obtained, speed information 503, and gravitational acceleration information 504 are displayed at the right side of the screen 500. Still image data is sequentially displayed at a rate of ten frames per second in an image display area 506. Reproduction, stopping, rewinding, and fast feeding are controlled by using an operation button 505. A shift of the gravitational acceleration information 504 is shown in a display area 507. An indicator 508 arranged below the display area 507 shows a reproduction time position of a still image currently displayed among a total time (three minutes).

Marks 510 and 511 described in the display unit 507 showing a shift of the gravitational acceleration information 504 show time when the operation SW 8 is pressed. This time display can be jumped to each mark by a shift button 509. A mark 512 described in the display unit 507 showing a shift of the gravitational acceleration information 504 shows a peak position of the gravitational acceleration information 504 in this file.

The time information 502, the speed information 503, the gravitational acceleration information 504, and the marks 510 and 511 showing the time when the operation SW 8 is pressed are displayed based on operation information corresponding to each still image data. The reproducing device 400 can reproduce video information and operation information by constant recording, by using this display screen.

What is claimed is:

1. A drive recorder recording information captured by an imaging unit into a nonvolatile recording medium, the drive recorder comprising:
a controller for controlling to constantly record information captured by the imaging unit into a nonvolatile recording medium, and record information captured by the imaging unit into a nonvolatile recording medium when a predetermined recording condition is established.

2. The drive recorder according to claim 1, wherein the controller cyclically records information constantly captured by the imaging unit into a first area of the nonvolatile recording medium, and cyclically records information captured by the imaging unit at the time of establishment of the recording condition into a second area of the nonvolatile recording medium.

3. The drive recorder according to claim 2, further comprising a detector for detecting a state of a vehicle, wherein the controller cyclically records information detected by the detector into the first area of the nonvolatile recording medium corresponding to information constantly captured by the imaging unit, and records information detected by the detector into a second area of the nonvolatile recording medium corresponding to information captured by the imaging unit at the time of establishment of the recording condition.

4. The drive recorder according to claim 2, further comprising an operation unit, wherein the controller cyclically records into the first area of the nonvolatile recording medium a fact that the operation unit is operated corresponding to information constantly captured by the imaging unit.

5. The drive recorder according to claim 1, wherein the controller controls not to record information constantly captured by the imaging unit into the nonvolatile recording medium when the recording condition is established.

6. The drive recorder according to claim 1, wherein information amount per unit time of information recorded into the nonvolatile recording medium at the time of establishment of the recording condition is set larger than information amount per unit time of information constantly captured by the imaging unit recorded into the nonvolatile recording medium.

7. The drive recorder according to claim 1, wherein information constantly captured by the imaging unit and recorded into the nonvolatile recording medium is divided into plural files, and these divided files are recorded into the nonvolatile recording medium.
